(19) United States
(12) Patent Application Publication
(10) Pub. No.: US 2002/0194064 A1
(43) Pub. Date: Dec. 19, 2002

(54) Methods and apparatus for promoting use of consumable goods in imaging devices

(76) Inventors: Travis J. Parry, Boise, ID (US); Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/873,094

(22) Filed: Jun. 1, 2001

(51) Int. Cl. G06F 17/60

(52) U.S. Cl. 705/14

(57) ABSTRACT

A method to promote the use of consumables in an imaging device. The method includes detecting consumption of a consumable. When the consumption of a predefined quantity of the consumable has been detected, a user of the imaging device is rewarded. The reward can be retrieved from an Internet site, or retrieved from a local memory device. The method can also include basing the reward on the value of the consumable product consumed, as well as on the origin of the consumable product. The step of detecting the consumption of the consumable can include calculating an estimated consumption of the consumable, including the consumption of an image forming substance such as ink or toner. The step of detecting the consumption of the consumable can also include counting the consumption of the consumable, such as sheets of media.

### FIELD OF THE INVENTION

The invention claimed and disclosed herein pertains to methods and apparatus for promoting the use of consumables used by imaging devices such as printers and photocopiers.

### BACKGROUND OF THE INVENTION

The present invention pertains to methods and apparatus for promoting the use of consumable goods or products which are used in image-forming devices. Examples of such imaging devices include photocopiers and printers, and particularly printers such as electrophotographic (or “laser”) printers and ink-jet printers. Another example of an image-forming device is an “all-in-one” device, which typically incorporates the functionality of a printer, a photocopier, a facsimile machine, and a scanner all in a single device. We will use the general term, “image forming device” or “imaging device” to refer to all such devices. These imaging-forming devices all use consumable products, or “consumables”. Generally, a consumable is any product which is used by the imaging device and which, if not resupplied, will eventually be consumed to exhaustion following sufficient use. Examples of consumables include the media on which the image is formed, as well as the substance(s) used to form the image itself. More specifically, the media can include paper and transparencies and the like. The substances used to form the image can include, for example, toner for use in an electrophotographic image forming process, and ink for use in an ink-jet or “bubble-jet” image forming process. Toner is frequently provided in a cartridge to reduce the opportunity for spills or other handling mishaps when the toner is being provided to the imaging device. Likewise, ink is typically provided in a container for the same reasons.

Often times manufacturers of imaging devices provide their own branded consumables for use by the imaging devices. While the consumables may not necessarily be manufactured by the imaging device manufacturer, the consumables are typically manufactured to a specification established by the imaging device manufacturer. Other times, when an imaging device manufacturer does not offer their own brand of consumables, they will recommend a specific brand of consumables for use in the imaging devices they manufacture.

However, often times a manufacturer of consumables who is not recommended by the imaging device manufacturer will offer “compatible” consumables at a lower cost than those brands of consumables recommended by the imaging device manufacturer. Such consumables may generally be “compatible” in that they can be physically accommodated by, and used by, the imaging device. However, frequently such non-recommended consumables produce lower quality images and can cause jamming, premature wear to the imaging device, or they can even damage or destroy the imaging device. For example, a refilled toner cartridge, under certain printing conditions, can rupture, essentially destroying the imaging device. All of which can have an adverse effect on the reputation of the manufacturer of the imaging device. It is thus desirable to encourage the user of an imaging device to use the recommended brand of consumables.

In addition to ensuring that recommended consumables are used in an imaging device, manufacturers of the recommended (or “branded”) consumables have an interest in having users purchase increased volumes of consumables, since the manufacturers realize profit from the sales of such branded consumables. It is thus desirable to find a way to encourage a user to purchase and use more branded consumables for imaging devices.

In order to encourage increased sales of such consumables, manufacturers or retailers will frequently provide a volume discount offer. For example, a manufacturer may offer for sale a box of paper containing four reams of paper for the price of three reams. Another incentive device is the rebate, wherein a buyer of a consumable product can receive a refund from the manufacturer of the consumable by showing proof of purchase. Frequently such rebates are “mail-in” rebates wherein the buyer mails in a coupon along with a proof of purchase. Other rebates are “instant rebates” which provide for a discount at the point of sale. Yet another method imaging device manufacturers and consumable manufacturers use to encourage sales of a particular brand of consumable is to include the consumable “free” with the purchase of the imaging device. For example, the manufacturer of an imaging device can provide a recommended toner cartridge, at no additional cost, with the purchase of an imaging device.

While these incentive programs can help to ensure that users purchase a recommended brand of consumable, they typically do not encourage increased consumption of the consumables. At most, such programs merely encourage purchases of larger quantities of the consumables. What is desirable then is a program which encourages consumers to not only buy a specific brand of consumable, but which also encourages consumers to use more of the consumables, versus merely buying larger quantities but at decreased intervals.

### SUMMARY OF THE INVENTION

The present invention provides method and apparatus to the promote the use and/or consumption of consumable product, or “consumables”, by a user of an image forming device (or “imaging device”) which uses the consumable product. The user is given or offered a “reward” based on actual use of the consumable products, versus the reward being based merely on the purchase of the consumable products. Sensors within the imaging device can be used to detect the use of the consumable products. The reward which is given or offered to the user can be based not only on the quantity of consumable product which is used, but also on the relative value of the consumable product, and on the source or origin (such as the supplier) of the consumable product.

A method in accordance with a first embodiment of the present invention includes detecting consumption of a consumable and, when the consumption of a predefined quantity of the consumable has been detected, rewarding a user of the imaging device. The imaging device can be provided with a consumption detection device to allow the detection of the quantity of the consumable product which has been consumed by the imaging device over a period of time. The reward can provided to the user as a “reward message” instructing the user how to claim the reward. The reward can be retrieved from a computer network, such as a site on the Internet, or it can be retrieved from a local memory device. Further, the reward can be printed using the imaging device. The method can also include basing the reward on the value of the consumable product consumed, as well as on the origin of the consumable product.

Another method in accordance with the present invention provides for a method to promote the use of a plurality of consumables in an imaging device. This method includes the steps of detecting consumption by the imaging device of individual quantities of the plurality of consumables. When a predefined collective or cumulative quantity of the individual quantities of consumables has been detected, a user of the imaging device is rewarded with a reward defined by a value. The value of the reward is based on the individual quantities of each consumable that has been detected as being consumed by the imaging device. The imaging device can be provided with a consumable consumption detection device, or devices, configured to detect the individual quantities of each of the consumable products which have been consumed by the imaging device over a period of time.

The invention also provides for a method to promote the use of a consumable in a plurality of imaging devices. The method includes detecting consumption of individual quantities of the consumable by each of the imaging devices and, when a predefined collective quantity of the individual quantities of consumable has been detected, generating a reward. The reward can be is generated by transmitting a message to an individual notifying the individual of the reward. The reward can also be generated by printing a reward coupon using at least one of the plurality of imaging devices. When the consumable can be provided by a plurality of separately identified sources, the method can also further include detecting at least one of the identified sources of the consumable product, and basing the reward at least in part on whether quantity of consumable which has been consumed comprises consumable provided by the at least one identified source. This third method can be combined with the second method to address the situation when the plurality of imaging devices collectively consume a plurality of consumables. In this case the method can further include detecting consumption by the plurality of imaging devices of individual quantities of the plurality of consumables. Then, when a predefined collective quantity of the individual quantities of consumables has been detected, a reward is generated. The reward can be defied by a value, and the method can include basing the value of the reward on the individual quantities of each consumable that has been detected as being consumed by the imaging devices.

A second embodiment of the present invention includes an apparatus for providing the user of a image forming device, which is configured to consume a consumable product (or “consumable”), with a reward based on a consumption of the consumable by the imaging device. The apparatus includes a consumption detection device configured to detect quantities of the consumable that are consumed by the imaging device. The consumption detection device generates consumption signals in response to detecting the consumption of the consumable. The apparatus also includes an electronic writeable memory device, and an electronic readable memory device configured to contain a user reward message. The writeable memory device and the readable memory device can be defined by separate memory addresses on a common readable-writeable memory device such as a random access memory (“RAM”) microchip. A processor is configured to receive the consumption signals and to store a consumption value in the electronic writeable memory device. The consumption value is a function of the received consumption signals. The processor is further configured to read from the readable memory device the user reward message when the consumption value is at least equal to a predetermined reward value, and to visually display the reward message to the user. “Visually displaying” the reward message can include providing a screen display message, or printing a coupon or the like using the imaging device itself. The reward message can be, for example, the reward itself in the form of a coupon, an offer to an individual for a discount, or a message informing the user how to claim the reward.

The apparatus can further include a communication device, such as an embedded Internet web server, which the processor can use to retrieve the user reward message from a remote location, such as an Internet web site.

In one variation, when the consumable can be provided by a plurality of suppliers, and at least one of which can be identified by inspection of the consumable product, the apparatus can further include a consumable identification detection device. The consumable identification device is configured to inspect the consumable and determine whether the consumable has been supplied by the identifiable supplier. If the identifiable supplier is detected by the identification device, then the detection device generates a supplier identification signal which can be used by the processor to determine whether a user reward message should be generated, and/or the value of the reward.

A third embodiment of the present invention includes a computer-readable storage medium for use by a processor, which is configured to execute computer executable instructions, to thereby generate a reward message for a user in response to the consumption of at least one consumable by an image forming device. The medium holds computer executable instructions to detect consumption of the at-least one consumable and, when the consumption of a predefined quantity of the at-least one consumable has been detected, to generate a reward message. The instruction to generate a reward message can include an instruction to print a coupon using the imaging device, or in can include an instruction to visually display a message to the user. The computer readable medium can further holding computer executable instructions to connect to a global computer network and to obtain, via the global computer network, a certificate verifying the reward. The instruction to connect to the global computer network and obtain the certificate verifying the reward can be configured to be executed automatically in response to a detection that the predefined quantity of the consumable has been consumed.

The instruction to detect the consumption of the consumable can include an instruction to calculate an estimated consumption of the consumable, as for example the estimated consumption of ink or toner used by the imaging device to generate images. When the imaging device forms an image by depositing a quantity of pixels of the image forming substance, the instruction to detect the consumption of the consumable can be an instruction to at least one of calculate, measure, or estimate the deposited quantity of pixels of the image forming substance. When the consumable can be provided by a plurality of separately identified sources, the computer readable medium can further hold computer executable instructions to detect at least one of the identified sources of the consumable, and to base the reward at least in part on whether the detected quantity of consumable that has been consumed comprises consumable provided by the at least one identified source. When the consumable comprises sheets of media, the instruction to detect the consumption of the consumable can be an instruction to count sheets of the media consumed by the imaging device.

These and other aspects and embodiments of the present invention will now be described in detail with reference to the accompanying drawings, wherein:

### DESCRIPTION OF THE DRAWINGS

FIG. 1 is a schematic diagram depicting an image forming device and collateral apparatus that can be used to implement the methods of the present invention.

FIG. 2 is a flow chart depicting a series of steps that can be implemented and executed to perform one variation of the present invention.

FIG. 3 is a flow chart depicting a series of steps that can be implemented and executed to perform a second variation of the present invention.

### DETAILED DESCRIPTION OF THE INVENTION

The present invention allows for the user of an image forming device (or “imaging device”) to earn “rewards” based on actual consumption of consumable products by the imaging device. The rewards can be, for example, a coupon that can be redeemed for free consumable product, or a discount on future purchases of consumable product. The imaging device is provided with at least one detection device (e.g., a sensor), or estimation device, which allows the use of a consumable product to be determined or estimated. For example, the detection device can determine the number of sheets of media that have been printed, or the use of toner or ink. Additionally, the imaging device can be provided with a consumable product supplier detection device which can be used to determine whether a consumable product is provided by a particular supplier. In this way, the reward can be based in whole, or in part, on whether or not the user is using recommended consumable products.

The reward can be provided to, or offered to, the user in the form of a reward message, which can take one or more of several forms. For example, the reward message can be displayed on a display screen prompting the user to print out a coupon. Alternately, the reward message can be the reward coupon itself, which can be automatically generated by the imaging device when a reward is earned. Although we will use the expression of providing the reward to a “user”, it is understood that the reward can be offered to any identified individual or entity. For example, when the reward is provided based on he consumption of at least one consumable by a plurality of imaging devices, as for example in an office or a corporate environment, the reward can be offered to a purchasing agent or the purchasing department that purchases the consumable(s) for the imaging devices.

The present invention can also be used in conjunction with a computer network, and in particular a global computer network such as the Internet. When the apparatus determines that the user has earned a reward, a communication device can be connected to the network and the user reward message can be downloaded from a remote server connected to the network. The reward message can then be displayed to the user.

We will now describe our invention in detail with reference to the attached drawings. In the following description we will use the term “image forming device” or “imaging device” to include any apparatus which is used to form images on sheets of media. For example, the imaging device can include a printer, a photocopier, and an “all-in-one” imaging device. Such imaging devices are frequently, but not always, in the form of a peripheral device that is connected to another device, such as a computer, which can be used to transmit images for printing to the peripheral device, as well as to provide additional functionality for the peripheral device. However, it should be understood that the term “imaging device” can also include stand-alone imaging devices, such as photocopiers, which are not necessarily connected to a computer or the like. Examples of the imaging processes used by imaging devices include laser imaging using an electrophotographic developing and imaging process, ink printing (such as an ink jet printing or a bubble jet printing), thermal imaging (wherein the image is formed on special thermally sensitive paper), and ribbon printing using a Mylar or cloth ribbon to convey an ink past a print head. The media on which the imaging device forms the image can include, for example, paper and transparencies. The paper can include not only standard white stock paper such as used for printing documents, but also other specialized paper, such as photographic quality papers, cardstock, envelopes, and thermally sensitive paper.

As mentioned, the reward is offered to the user as a result of using consumable products, or “consumables”. A “consumable” is any portion of the image forming device that is configured to be replaced one or more times during the life of the image forming device. Consumables can include, for example, various types of media on which an image is formed by the imaging device, as well as image forming substances. Examples of an image forming substance can include toner which is deposited on the media to form the image, as well as ink. Typically toner is provided in a toner cartridge, and ink is provided in a container, and the cartridge or container can be installed directly into the imaging device. Thereafter, the toner or ink is drawn from the cartridge or container by the imaging device as the image is formed, removing the need for the user to empty the contents of the cartridge or container into a receptacle for use by the imaging device. “Consumables” used by an image forming device can also include fusers (for fusing toner onto a sheet of media), transfer belts (for transferring toner to a sheet of media prior to fusing), pick rollers (for picking sheets of media from an infeed tray or the like), optical photoconductors, toner cartridges, toner hoppers, ink containers, and ink bottles.

In the following discussion, we will first describe apparatus which can be used to implement the methods of the present invention. We will then discuss various manners in which the apparatus can be used to implement the present invention.

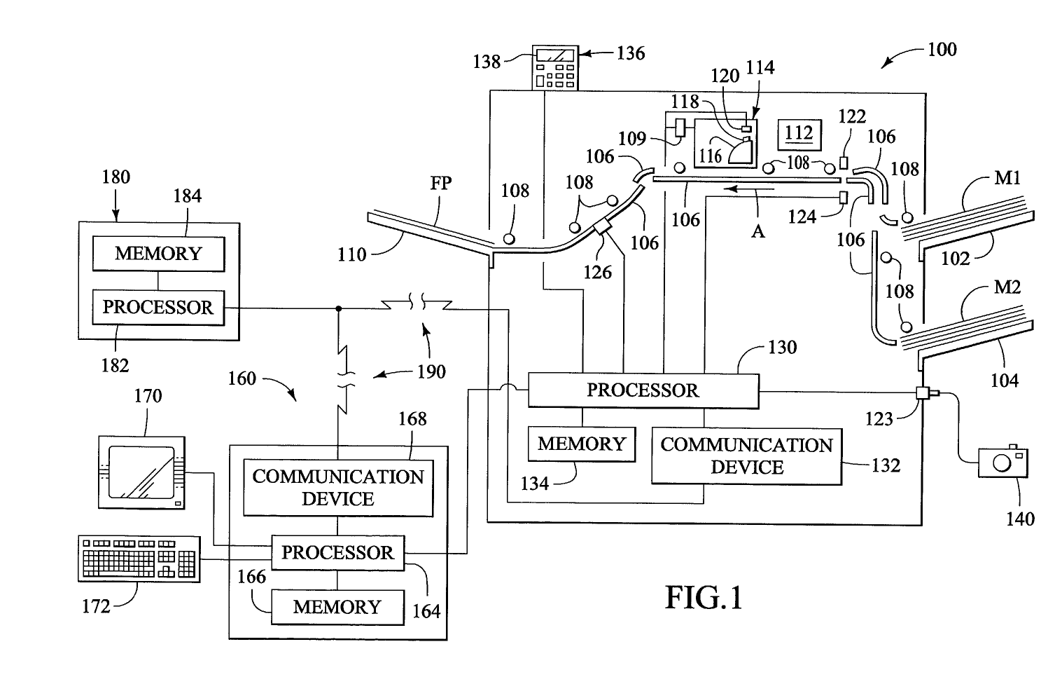

Turning now to FIG. 1, a schematic diagram depicts an image producing (or image forming) device 100 which can be used to implement the methods of the present invention. The imaging device 100 is shown as being connected to a personal computer or workstation 160, although as previously mentioned, this is not a requirement. A remote server 180 is also depicted, which in one variation can be connected to the imaging device 100 via the computer network 190. The computer network 190 can be, for example, a global computer network, such as the Internet, or a local area network (“LAN”), or a wide area network (“WAN”).

The imaging device 100 has media input trays 102 and 104 which can contain sheets of printable media, respectively M1 and M2. The sheets of media are moved by rollers 108 in direction “A” along a feed path defined by media guides 106. The finished or printed sheets are ultimately discharged in an output tray 110 as finished product “FP”. The image forming substance (toner or ink, typically) is deposited on the sheets of media by the image forming section 114. When the imaging device 100 uses an electrophotographic image forming process, a developing section 112 is included which forms the image on a transfer medium (not shown), and the toner is then transferred from the transfer medium to the sheets. When the image forming device 100 uses an ink deposition image forming process, then a developer section is typically not included, and the image is formed directly on the sheets of media by the image forming section 114. Since techniques of forming an image on a sheet of media are well known, they will not be discussed further herein, and are generally not germane to the methods and apparatus of the present invention.

The image forming device 100 further includes a processor, such as a microprocessor. The processor is generally configured to execute a series of computer executable instructions (a “program”) to provide operational capability to the imaging device, as well as to provide enhanced functionality, such as the reward system of the present invention. Specifically, the processor can access a “reward program” comprising a set of executable steps to be performed by the processor to determine if a reward message should be generated, and the specific message to be generated. The reward program can be stored in a memory device such as memory device 134. The processor used by the imaging device 100 can be an internal processor 130, or an external processor, such as the processor 164 in the workstation 160. Further, both processors 130 and 164 can be provided, and can work in conjunction with one another. The processor 130 is in electronic signal communication with an electronic writeable memory device and an electronic readable memory device, which are preferably combined in the readable-writeable memory device 134. An example of such a device is a hard drive or random access memory (“RAM”) on a microchip. Although the image forming device 100 is shown as having the internal memory device 134, the processor 130 can also be in signal communication with an external memory device, such as the readable-writeable memory device 166 in the workstation 160.

The image forming device 100 can further be configured to communicate with the communication network 190 via a computer network communication device. One example of the network communication device is the embedded web server 132, which allows the imaging device 100 to connect directly to the network. Embedded web servers are described in U.S. Pat. No. 5,956,487, incorporated herein by reference. Alternately, the imaging device 100 can gain access to the network via the communication device 168 in the workstation 160. The communication device 168 can be, for example, a modem or a network interface card. The processor 130 or 164 can be configured to automatically connect to the network 190 upon the occurrence of a particular event, using the communication device 132 or 168. Alternately, the connection to the network 190 can be made following receipt by the processor of an instruction from a user. The instruction to the processor 130 or 164 can be entered via a user interface, such as the user interface 136 on the imaging device 100, or via the keyboard 172 which is connected to the workstation 160. By connecting to the network 190, the processor 130 or 164 is able to obtain information from a remote server, such as server 180, which is depicted as having a remote server processor 182 and a remote server memory device 184.

Preferably, the processor 130 of the image forming device 100 (or processor 164 of workstation 160) is configured to display messages, such as the reward message, to a user. The messages can be displayed visually, for example, by a small display device 138 in the user interface 136 which is part of the imaging device 100. The message can also be displayed via a display device such as display screen 170 which is part of the computer 160. Further, the message can be displayed by printing the message on a sheet of printable medium using the imaging device 100, and depositing the printed message in the output tray 110.

The image forming device 100 is configured to print images on media, as previously described. The source for the image to be printed can be a scanned image, such as when the imaging device 100 has photocopier capabilities. A scanner (not shown) for scanning the image to be photocopied can be an integral part of the imaging device 100. The source for the image can also be an electronic digitized stream of data which is transmitted to the processor 130 and thereafter formatted for printing by the image producing unit 114. The digitized data can be provided, for example, from the computer 160, or from a digital camera 140 which is configured to communicate with the processor 130 via a communication port 123. The digitized data can be transmitted through physical links such as wire or optical fiber cable, as well as by wireless techniques and protocols such as infrared, radio frequency, or the recently developed Bluetooth short range wireless communication protocol. (Bluetooth is a trademark of Telefonaktiebolaget LM Ericsson CORPORATION SWEDEN.)

As mentioned previously, the image forming device 100 is provided with at least one consumption detection device. A consumption detection device is any device that can detect the usage of a consumable product by an image forming device, and can then generate a consumption signal in response to detecting such usage. The processor 130, 164 can then use the consumption signal to determine if and when a reward message should be generated. In FIG. 1, the imaging device 100 is provided with a media sheet counter which is configured to count the sheets of media which have been passed through the feed path defined by guides 106. One example of a sheet counter is the light source 122 and light detecting sensor 124. Since sequential sheets of media passing through the feed path are typically separated by a small gap, when a sheet of media is passing between the light source 123 and the light sensor 124, the sensor 124 does not detect the light. However, after a sheet of media has passed this point, the sensor 124 can then detect the light from the source 123. In this way each sheet of media which passes by the sensor 124 can be individually detected. The sensor 124 can transmit an electronic signal to the processor 130, which can store the cumulative count of sheets detected by the sensor 124 in the memory device 134.

A second consumption detection device can include a device to detect the consumption of the image forming substance, such as toner or ink. For example, the image forming device 100 can include a pixel counter 109 which counts the number of pixels which are transmitted by the processor 130 to the image forming section 114. Since each transmitted pixel corresponds to the consumption of a relatively known quantity of toner or ink used to form the image, by counting the total number of pixels transmitted to the image forming section 114 over a period of time, the processor can determine the approximate quantity of the image forming substance that has been consumed by the image device 100 over the same period of time. While the pixel counter 109 is depicted as a specific component in FIG. 1, the counter can also be in the form of a pixel tracking program which tracks and records the pixels transmitted to the image forming section 114. The pixel tracking program can not only count the total transmitted pixels, but it can also be configured to track specific colors of transmitted pixels in a color imaging device (i.e., an imaging device configured to produce an image using two or more colored image forming substances). Further, when the processor 130 is configured to vary the density of toner or ink deposited for each pixel (for example, to provide shading, or to provide color tones in a color imaging device), then the pixel tracking program can be configured to adjust the estimated quantity of image forming substance for an individual pixel based on the density assigned to the pixel. In this manner the pixel tracking program can store “consumption signals” in the memory device 134 which are indicative of the quantity of image forming substance that has been consumed by the imaging device 100.

Another example of a consumable consumption detection device which can detect the consumption of the image forming substance is a cartridge/container sensor 120 located in the image forming section 114. The cartridge/container sensor 120 can determine when a cartridge or a container holding image forming substance is present. Thus, when a cartridge or container is removed for replacement, the cartridge/container sensor 120 generates a consumption signal that can be used by the processor 130 to determine if a reward message should be generated. For example, if a user changes a toner cartridge, then a reward message can be generated to provide the user a discount coupon which can be redeemed towards the purchase of a replacement cartridge. However, the removal and installation of an image forming cartridge or container does not always correspond to replacing an empty cartridge. Thus, a user could potentially cause the processor 130 to generate multiple discount coupons merely by removing and reinserting the same cartridge a number of times. Further, merely detecting the presence or absence of the cartridge does not recognize that the user may be using a cartridge which is supplied by a non-recommended supplier. Accordingly, it is preferable to use a more advanced cartridge/container sensor 120 which can address these problems, as will now be described.

Rather than merely provide a cartridge/container sensor for the consumption detection device 120, as described above, preferably the consumable consumption detection device 120 is a consumable identification detection device which allows the particular type of consumable product being used to be identified. Preferably, the consumable identification detection device uses Automatic Identification and Data Capture (AIDC) technology. AIDC technology provides for the direct entry of data into a computer system, programmable logic controller (PLC) or other microprocessor-controlled device without using a keyboard. For example, the cartridge or container can be provided with a bar code or magnetic ink that can be read by the sensor 120. The bar code or magnetic ink can identify, for example, at least one of a plurality of possible manufacturers or suppliers of cartridges or containers. This information can then be detected by an appropriate sensor 120 and transmitted to the processor 130 as a supplier identification signal. The processor can then determine if a reward should be provided for use of the image forming substance in the cartridge or container, or the reward can be modified (e.g., a different reward, or a different value for the reward) based on the identified manufacturer or supplier.

Another AIDC technology that can be used to specifically identify the cartridge or container is radio frequency identification (RFID). In this case the cartridge or container 116 can be provided with a transponder or “RFID tag” 118. The cartridge/container sensor 120 can then comprise an antenna or coil and a transceiver which allow the RFID tag to be read and the information relayed to the processor 130. The RFID tag can be passive (in which case it only provides pre-recorded information to the transceiver), or it can be active, in which case it can also receive and record information from the processor 130. The RFID tag can contain information pertaining not only to the manufacturer or supplier or the container or cartridge, but it can also provide a unique identification number such that each container or cartridge can be uniquely identified by the processor 130. The RFID tag can contain additional information, such as the specific image forming substance contained within the cartridge or container and the date the unit was manufactured. In this way, the processor can determine whether a different cartridge or container has been placed in the imaging device 100, or whether the cartridge or container has merely been removed and then reinstalled into the imaging device 100.

If an active RFID tag is used to identify the cartridge or container, and if the imaging device 100 is provided with a pixel counter 109 or other device which can determine the estimated or specific quantity of image forming substance that has been used by the imaging device, then the processor can store on the RFID tag the quantity of image forming substance used. Thus, if a cartridge or container is removed and replaced with a different unit, the processor can determine whether the removed cartridge or container was nearing depletion. If it is determined that the cartridge or container was not nearing depletion, then the reward program used by the processor can be configured to not generate a reward message, even though the cartridge has been removed and replaced. This helps to ensure that a user essentially depletes the cartridge or container before a reward is offered for consumption of the substance contained therein.

Yet another form that the consumable identification detection device can take is a sheet media identifier 126. Again, preferably this detection device uses AIDC technology. Sheets of media can be imprinted with an identifier which can be detected by the sheet media identifier 126. The identifier can include such information as the manufacturer or supplier of the media, the grade or quality of the media, and the size of the media. While the identifier can be visible such as a bar code printed in black ink, it can also be printed with an ink or other substance which is essentially invisible to the human eye, but can be detected by an appropriate sensor. For example, the back side of sheets of photographic media can be printed with an ink that is visible only under ultraviolet light, and the sensor 126 can then be configured to read the identifier at the visible frequency. In this manner, the media can bear a non-intrusive identifier which will not interfere with the printed image, but can provide useful information upon which to base a reward for consumption of the media. The resulting signal from the sensor 126 can then be transmitted to the processor 130 and used to determine the specific type of media being used. The processor can be provided with a look-up table, stored in the memory device 134, which can associate a particular reward value with a particular identified media. For example, if a user is using a large size, high quality media for printing photographic grade images, then the look-up table can be configured to assign a high reward value to this particular media. Likewise, if a smaller, but equal quality, photo-grade media is used, a smaller reward value can be assigned. Further, use of the media identifier and a look-up table allows a reward to be provided for the specific media being used from a plurality of available types of useable media. For example, if a specific size and grade of media is being used and is detected by the sensor 126 and identified by the processor 130, then the reward can be provided for only this particular type of media.

Accordingly, an apparatus in accordance with the present invention comprises a consumable consumption detection device (one or any combination of 109, 120, 122/124, and 126) configured to detect (or estimate, in the case of the pixel counter 109) quantities of the consumable product that are consumed by an imaging device. The detection device generates consumption signals in response detecting (or estimating) the consumption of the consumable products. The apparatus further includes an electronic writeable memory device 134 and/or 166, and an electronic readable memory device (134 and/or 166). The readable memory can contain a user reward message. The apparatus also has a processor (130 and/or 164) configured to receive the consumption signals and to store a consumption value in the electronic writeable memory device (134 and/or 166). The consumption value is a function of the received consumption signals. The processor 130 and/or 164 is further configured to read from the readable memory device 134 and/or 166 the user reward message when the consumption value is at least equal to a predetermined reward value, and to visually display the reward message to the user. The reward message can either be stored in the readable memory device after being retrieved from an external source (such as the Internet), or it can be resident within the memory device when the apparatus is manufactured, or it can be generated by a local processor and stored in the memory device.

It can thus be seen that an apparatus in accordance with the present invention does not need to be contained in a single unit, such as the imaging device 100, or the computer 160. Rather, the various components which comprise apparatus in accordance with the present invention can be contained in one or more units.

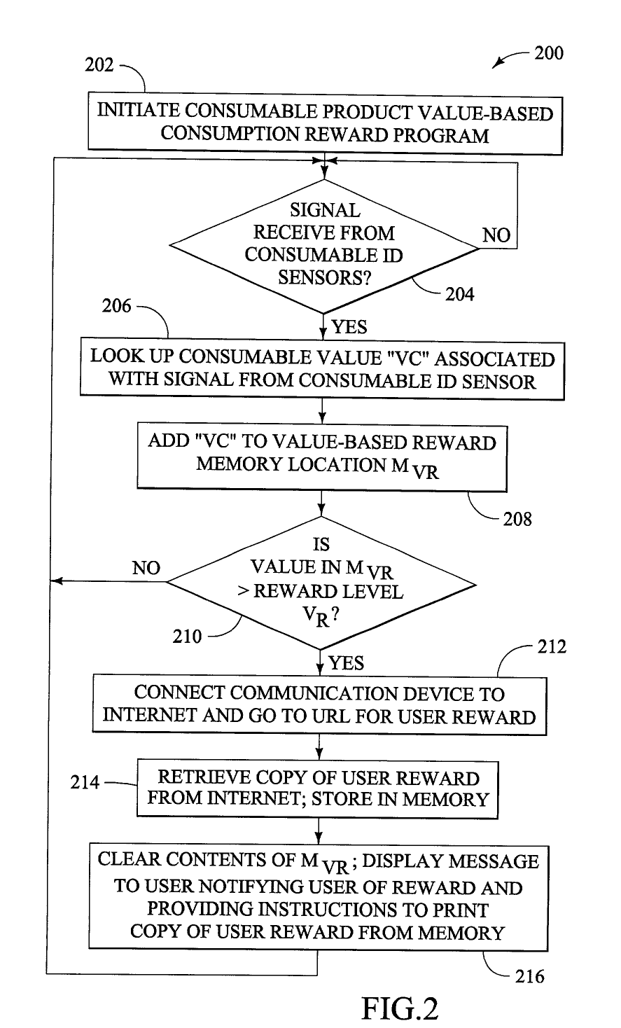

We will now describe various manners in which the apparatus described above with reference to FIG. 1 can be used to implement the methods of the present invention. Turning to FIG. 2, a flow chart 200 depicts one method of providing a reward to a user based on measuring the use of a consumable product such as paper, as well as the relative value of the consumable product, and generating a reward message when it is determined that a predefined total value of the consumable product has been consumed. In this manner the value of the reward, or the offering of the reward, can be based on the individual consumable product values, as well as the relative quantities consumed, of each consumable product that has been consumed by the imaging device 100. The detection of the consumable product, and its relative value, can be accomplished using the sheet media identifier 126 described and discussed above. The steps of the flow chart 200 can be implemented as a series of computer executable steps in the reward computer program which can be stored in the memory device (134 and/or 166) and executed by the processor (130 and/or 164).

The value-based consumption reward program is initiated at step 202 which initiates a memory location “M_{VR}” where the cumulative value of consumed media will be recorded. Typically, the memory location M_{VR} is initiated at zero. At step 204 the processor 130 polls the sheet media identifier 126 to determine whether a signal has been received, indicating that a sheet of media (at least, a sheet of identifiable media) has been consumed by the imaging device 100. If no signal has been received, the processor again polls the sensor 126. However, if a sheet of identifiable media has been detected, then at step 206 the processor receives the signal from the sensor 126 and determines from a look-up table (which can be stored in memory device 134) the consumable value “VC” assigned to the particular identified media. This value is then added to the contents of the cumulative media value memory location M_{VR} at step 208. In step 210 the processor compares the value in the memory location M_{VR} to a predetermined reward level value V_{R} to determine if the reward level has been achieved. If not, the processor returns to step 204 to poll for more signals from the sensor 126.

However, if at step 210 it is determined that the reward level V_{R} has been achieved based on usage of the identified media, then at step 212 the processor 130 issues instructions for the embedded web server 132 to connect to a server 180 on the Internet 190. The processor can then download from the remote server a user reward message, and store the message in temporary memory 134, as indicated in step 214. At step 216 the processor clears the contents of the cumulative media value memory location M_{VR}, and displays a message to the user notifying the user that he or she has earned a reward based on usage of a consumable product. The message can be displayed for example on the computer display 170, or the user interface display 138. The message can also instruct the user how to collect the reward. Thereafter, the program returns to step 204 to poll for more signals from the sensor 126.

The reward message obtained from the server 180 can be, for example, a coupon or a certificate which can be redeemed to purchase consumable product at a discount over the standard retail price, or for free consumable product, and the message displayed to the user can be a copy of the coupon printed by the imaging device 100. Alternately, the message displayed to the user can be of the form, “You have earned a discount on your next purchase of product X. To print coupon, press “Enter”.” Another form of message can inform the user that if he or she orders a specific product from a specific on-line retail web site, the user will be provided a discount by entering a given code into a particular field when placing the order on-line. In this case the message can include a universal resource listing (“URL”) directing the user to the retail web site. In another variation the message can be transmitted to the user as an e-mail from the web site 180, informing the user of the reward. The e-mail can include a hyperlink to an on-line retail site where the user can order consumable product. The on-line retail site can automatically offer the reward to the user once the user connects to the web site, since a web server can identify the source of a user connecting to the a site served by the server.

A number of variations of the method depicted by the flow chart 200 can be implemented. For example, rather than automatically connecting to the Internet, the processor can retrieve and display a message instructing the user to connect to the Internet to retrieve the reward message. Further, the connection to the Internet can be made using the communication device 168 through the workstation 160, as opposed to using an embedded web server 132. Also, rather than retrieving the reward message from the Internet at step 214, the reward message can be retrieved from the memory device 134, where the message has been previously stored. Alternately, the reward program can contain executable steps to generate a reward message specific to the type and quantify of media consumed.

Further, rather than basing the reward on the cumulative value of all identifiable media consumed, the reward program can be configured to cause the processor to save reward values for a plurality of separately identified consumable products in separate memory locations (e.g., M_{VR}n, where n is equal to the number of separate reward conditions to be tracked). In this case a separate reward can be offered for each identified consumable product which is consumed.

The basic flow chart 200 of FIG. 2 can also be adapted to provide a reward based on one or more consumption detection devices determining that a predefined quantity of consumable product has been consumed by the imaging device 100. For example, if the imaging device 100 is provided with the sheet counter 124, then step 206 of the flow chart can be eliminated, and the consumable value “VC” is merely an increment, and the reward level V_{R} at step 210 corresponds to a predetermined total number of sheets of media detected by the sheet counter 124. Likewise, if the imaging device 100 is provided with the pixel counter 109, described and discussed above, then the same modifications are made to the reward program, except that the reward level V_{R} at step 210 corresponds to a predetermined total quantity of the image forming substance determined (or estimated) to have been consumed by the imaging device 100.

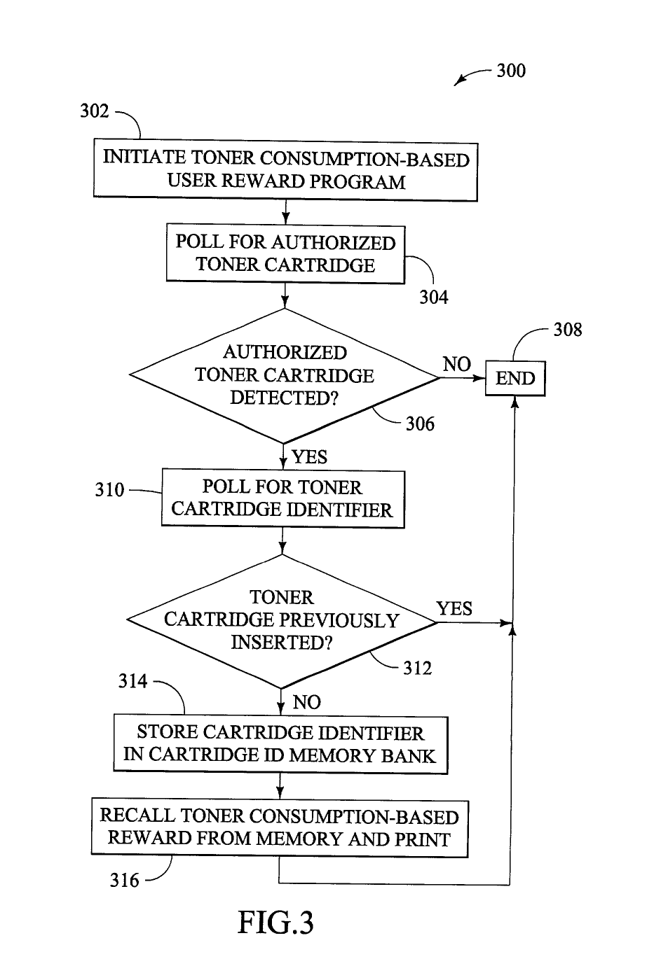

Turning now to FIG. 3, a flow chart 300 depicts one method of providing a reward to a user based on replacing a cartridge or container of image forming substance (such as toner or ink) with a different cartridge. The flow chart is based on offering a reward when a toner cartridge is replaced, although it is understood that the method is equally applicable to any replaceable unitized consumable product, as defined above. In the embodiment depicted, a reward is generated the first time a new toner cartridge is inserted into the imaging device. The program steps set forth in FIG. 3 assume that the toner cartridges upon which a reward can be based are identified using AIDC technology, discussed above. Preferably, the AIDC technology used is RFID technology, also discussed above. In this manner, when the toner can be provided by a plurality of separately identified sources, only one or some of which are recognized by the entity offering the reward as an authorized source, the reward can be offered only when toner cartridges from the authorized source are used. Further, the RFID technology allows the processor to determine if a toner cartridge has been previously inserted, so that a reward is only offered when a “new” toner cartridge is placed in the imaging device 100.

The toner consumption based reward program is initiated at step 302 when the transceiver 120 detects that a toner cartridge has been inserted into the imaging device 100. At step 304 the transceiver 120 polls the toner cartridge for an RFID tag 118 and to determine if the toner cartridge has been supplied by an authorized provider. If no RFID tag is present, or the cartridge has not been provided by an authorized supplier, then at step 308 the program is terminated, and no reward is offered. This can be detected by the absence of a signal from an RFID tag, or an unrecognized signal. However, if the transceiver 120 does determine that the cartridge has been provided by an authorized supplier, then at step 310 the transceiver can poll the toner cartridge RFID tag 118 to obtain an identifier which uniquely identifies the particular toner cartridge that has been installed in the imaging device. This step can also be performed at step 304, and thus step 310 can be eliminated.

At step 312 the processor 130 determines whether the cartridge has been previously installed into the imaging device 100. This can be accomplished by storing in the memory device 134 the cartridge identifiers of all cartridges previously installed in the imaging device 100, and then checking to determine whether the identifier of the presently installed cartridge matches the identifiers of any previously installed cartridge. If the processor determines that the cartridge has been previously installed, then at step 308 the program is terminated and no reward is offered. However, if the processor determines that the cartridge identifier is new (indicating that the cartridge has not previously been installed in the imaging device 100), then at step 314 the processor 130 stores the new cartridge identifier in the identifier memory bank in memory device 134, and proceeds to step 316. At step 316 the processor recalls from the memory device 134 a toner-consumption based reward, and prints the reward to the user. The reward can be, for example, a coupon which can be redeemed for a discount when another toner cartridge is purchased from an authorized supplier.

As with the value-based reward program depicted in FIG. 2, a number of variations can be made to the toner-consumption based program depicted in FIG. 3. For example, all of the variations pertaining to the type of reward which can be offered, the manner in which the reward can be retrieved (e.g., from the Internet or from the local memory device), and the manner in which the reward can be displayed to the user, can be accommodated. Further, the reward program can be modified to offer the reward only after a certain number of new cartridges have been installed into the imaging device 100. For example, the reward program can offer a reward of a free toner cartridge after five new cartridges have been consumed.

Further, if the toner cartridge is provided with an active RFID tag which allows data to be stored on the tag, and if the imaging device 110 is provided with a data transmitting device allowing the processor 130 to write data on the active RFID tag, then the processor can store on the RFID tag an identifier identifying the imaging device in which the cartridge was inserted. The memory location where the imaging device identifier is stored on the RFID tag can be configured to only be written to the first time the cartridge is inserted into an imaging device. Thus, at step 312 when the processor checks to determine whether the cartridge was previously inserted in the imaging device, the processor can also check to determine whether the cartridge is associated with the imaging device. If it is not, then the reward can be denied. This will help prevent a user from inserting a particular cartridge into a plurality of imaging devices in order to generate a plurality of user rewards. Since users rarely move a cartridge between printers during normal use of the cartridge, there is little risk that a user will be denied a reward as a result of the cartridge being used in two or more different imaging devices.

In one variation on the methods described above, the user can be offered an option to accept the offered reward, or to not accept the reward in lieu of a more valuable reward following future usage of consumable products. In this variation the reward can be offered in the form of points. The user can then elect to either redeem the points for a gift or a discount, or to accumulate the points for later redemption for a more valuable gift or discount.

It is understood that the reward does not necessarily need to be based on the use of consumable products provided by the manufacturer of the imaging device. For example, the manufacturer of the imaging device can arrange with a specific supplier of consumable products (such as a manufacturer or a retailer) to jointly implement the reward system. As one example, when the reward message is displayed to the user in any of the manners described above, it can direct the user to an identified retailer to collect the reward. Further, the reward itself does not necessarily need to be related to the consumable products upon which the reward is based. For example, the reward can be for free food at a fast-food restaurant based on using a predetermined quantity of media on which images are printed by the imaging device. The reward can also be free, or discounted, devices such a digital camera or a copier attachment for a printer. In general, the reward can be anything of value.

Accordingly, a second embodiment of the present invention includes a method to promote the use of consumable product (or a “consumable”) by the user of an imaging device (as for example, imaging device 100 of FIG. 1). The method includes the steps of detecting the consumption of the consumable and, when the consumption detection device detects that a predefined quantity of the consumable product has been consumed, offering to the user a reward. The reward can be “offered” to the user by printing a tangible copy of a coupon or certificate which can be redeemed to claim the reward, or by displaying a “reward message” to the user on a display screen or the like. The reward message can provide the user with instructions to claim the reward. The method can include the steps of providing the imaging device with a consumption detection device (as for example, the media sheet counter 124, the sheet media identifier 126, or the cartridge/container sensor 120 of FIG. 1) configured to detect a quantity of the consumable product that has been consumed by the imaging device over a period of time. When a consumption detection device is provided, the step of detecting the consumption of the consumable can be performed using the consumption detection device.

The method can also include the step of connecting to a global computer network (such as network 190) and obtaining, via the global computer network, a certificate verifying the reward offered to the user. The certificate can be provided from a remote server, such as server 180. The method can further comprise providing the imaging device with an embedded web server, such as server 132. In this case, the step of connecting to a global computer network and obtaining a certificate verifying the reward can be performed automatically in response to the consumption detection device detecting that a predefined quantity of the consumable product has been consumed.

When the imaging device consumes individual quantities of a plurality of consumable products, and the consumption detection device is configured to detect the individual quantities of each of the consumable products that have been consumed by the imaging device over a period of time, then the method can include the step of detecting the consumption of the plurality of consumable products with the consumable consumption detection device. Then, when the consumption detection device detects that a predefined collective quantity of the consumable products has been consumed, the reward is offered to the user. The value of the reward can be based on the relative quantities of each consumable product which have been consumed by the imaging device. When each of the consumable products are defined by individual consumable product values, the method can further include basing the value of the reward on the individual consumable product values.

Further, when the consumable product can be provided by a plurality of separately identified sources, and when the consumable consumption detection device is configured to detect at least one of the identified sources of the consumable product, the method can further include basing the reward, at least in part, on whether the consumption detection device has detected that the quantity of consumable product that has been consumed is consumable product provided by the identified source.

An alternate method of the present invention includes a method to promote the use of a consumable in a plurality of imaging devices, such as in an office or a corporate environment. The method includes detecting consumption of individual quantities of the consumable by each of the imaging devices and, when a predefined collective quantity of the individual quantities of consumable has been detected, generating a reward. The reward can be generated by transmitting a message to an individual or an entity notifying the individual or entity of the reward. The reward can also be generated by printing a reward coupon using at least one of the plurality of imaging devices. The consumption of the consumable product(s) can be detected using any of the consumption detection devices described above. When the consumable can be provided by a plurality of separately identified sources, the method can further include detecting at least one of the identified sources of the consumable product, and basing the reward at least in part on whether quantity of consumable which has been consumed comprises consumable provided by the at least one identified source. Further, when the plurality of imaging devices collectively consume a plurality of consumables, the method can further include detecting consumption by the plurality of imaging devices of individual quantities of the plurality of consumables. Then, when a predefined collective quantity of the individual quantities of consumables has been detected, the reward can be generated. In this case, the reward can be defined by a value, and the value of the reward can be based on the individual quantities of each consumable that has been detected as being consumed by the imaging devices.

A third embodiment of the present invention includes a computer executable program (a “reward program”) for implementing the methods of the present invention. The embodiment comprises a computer-readable storage medium for use by a processor configured to execute computer executable instructions (i.e., a “program”) to generate a reward message for a user in response to the consumption of consumable products by an imaging device. The computer readable medium can be, for example, a diskette, a hard drive, a compact disk, or a memory chip. Memory devices 134 or 166 of FIG. 1 can be used as the computer readable medium. The processor can be, for example, processor 130 or 164, and the imaging device can be, for example, imaging device 100. The computer readable medium holds computer executable instructions to receive consumption signals from a consumption detection device configured to detect quantities of the consumable product which are consumed by the imaging device. Examples of the consumption detection device include, without by way of limitation, the media sheet counter 124, the sheet media identifier 126, the cartridge/container sensor 120, and the pixel counter 109. The computer executable instructions also include an instruction to calculate a consumption value as a function of the received consumption signals and to store the consumption value in a readable memory device, such as memory device 134 or 166. The consumption value can be merely an incremental counter, as in the case of using the sheet counter 124. However, the consumption value can also be a weighted value based on the relative value and quantity of the consumable product that is consumed, as when the sheet identifier 126 is employed. There is further included computer executable instructions to determine when the consumption value is at least a predetermined reward value, and to generate the reward message when the consumption value is at least equal to the predetermined reward value. Finally, the program includes an instruction to visually display to the user the reward message. The various forms which the reward message can take, and the manner in which the reward message can be presented to the user, have been described above.

In one variation, the computer-readable storage medium can further hold computer executable instructions to connect a computer network communication device, such as the embedded web server 132 or the communication device 168, to a global computer network 190. An instruction can then be included to obtain from the global communication network a reward file, and to use the reward file to generate the reward message. In another variation the computer-readable storage medium can hold computer executable instructions to receive a supplier identification signal from a consumable identification detection device, such as the the cartridge/container sensor 120 which is configured to inspect the consumable product. Instructions can then be included to allow the processor to detect whether the consumable product has been supplied by a predetermined supplier. Preferably, the predetermined supplier is a supplier which is authorized by the entity offering the reward, such that no reward, or a reduced reward, is offered if the supplier is not a predetermined supplier. The computer readable medium further includes an instruction to use the supplier identification signal to calculate the consumption value. For example, if the supplier identification signal indicates that the supplier is an predetermined supplier, then the consumption value can be 1, but if the supplier identification signal indicates that the supplier is not a predetermined supplier, then the consumption value can be zero.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method to promote the use of consumables in an imaging device, comprising:
detecting consumption of a consumable; and
when the consumption of a predefined quantity of the consumable has been detected, rewarding a user of the imaging device.

2. The method of claim 1, and wherein rewarding a user comprises printing a coupon using the imaging device.

3. The method of claim 1, and further comprising connecting to a global computer network and obtaining, via the global computer network, a certificate verifying the reward.

4. The method of claim 3, and wherein connecting to a global computer network and obtaining the certificate verifying the reward is performed automatically in response to detecting that the predefined quantity of the consumable has been consumed.

5. The method of claim 1, and wherein the detecting the consumption of the consumable comprises calculating an estimated consumption of the consumable.

6. The method of claim 1, and wherein the consumable can be provided by a plurality of separately identified sources, the method further comprising detecting at least one of the identified sources of the consumable, and basing the reward at least in part on whether the predefined quantity of consumable that has been consumed comprises consumable provided by the at least one identified source.

7. The method of claim 1, and wherein the consumable is defined by a standard retail price per unit of the consumable, and further wherein the reward allows the user to obtain the consumable at a discount over the standard retail price.

8. The method of claim 1, and wherein the consumable comprises sheets of media, and detecting consumption of the consumable comprises counting sheets of the media consumed by the imaging device.

9. The method of claim 1, and wherein the consumable comprises an image forming substance, the imaging device forms an image by depositing a quantity of pixels of the image forming substance, and detecting consumption of the image forming substance comprises at least one of calculating, measuring, or estimating the deposited quantity of pixels of the image forming substance.

10. A method to promote the use of a plurality of consumables in an imaging device, comprising:
detecting consumption by the imaging device of individual quantities of the plurality of consumables;
when a predefined collective quantity of the individual quantities of consumables has been detected, rewarding a user of the imaging device with a reward defined by a value; and
basing the value of the reward on the individual quantities of each consumable that has been detected as being consumed by the imaging device.

11. The method of claim 10, and wherein each of the consumables are defined by individual consumable values, the method further comprising basing the value of the reward on the individual consumable values.

12. A method to promote the use of a consumable in a plurality of imaging devices, comprising:
detecting consumption of individual quantities of the consumable by each of the imaging devices; and
when a predefined collective quantity of the individual quantities of consumable has been detected, generating a reward.

13. The method of claim 12, and wherein the reward is generated by transmitting a message to an individual notifying the individual of the reward.

14. The method of claim 12, and wherein the reward is generated by printing a reward coupon using at least one of the plurality of imaging devices.

15. The method of claim 12, and wherein the consumable can be provided by a plurality of separately identified sources, the method further comprising detecting at least one of the identified sources of the consumable product, and basing the reward at least in part on whether quantity of consumable which has been consumed comprises consumable provided by the at least one identified source.

16. The method of claim 12, and wherein the plurality of imaging devices collectively consume a plurality of consumables, the method further comprising:
detecting consumption by the plurality of imaging devices of individual quantities of the plurality of consumables;
when a predefined collective quantity of the individual quantities of consumables has been detected, generating a reward defined by a value; and
basing the value of the reward on the individual quantities of each consumable that has been detected as being consumed by the imaging devices.

17. Apparatus for providing the user of a imaging device, which is configured to consume a consumable, with a reward based on a consumption of the consumable by the imaging device, comprising:
a consumable consumption detection device configured to detect quantities of the consumable that are consumed by the imaging device and to generate consumption signals in response thereto;
an electronic writeable memory device;
an electronic readable memory device configured to contain a user reward message;
a processor configured to receive the consumption signals and to store a consumption value in the electronic writeable memory device, the consumption value being a function of the received consumption signals, the processor further configured to read from the readable memory device the user reward message when the consumption value is at least equal to a predetermined reward value, and to visually display the reward message to the user.

18. The apparatus of claim 17, and further comprising a display device, and wherein the processor visually displays the reward message using the display device.

19. The apparatus of claim 17, and wherein the readable memory device is a readable-writeable memory device, the apparatus further comprising a computer network communication device, and wherein the processor is further configured to access a global computer network via the computer network communication device when the consumption value is at least equal to the predetermined reward value and to obtain from the global computer network the reward message, and to store the reward message in the readable-writeable memory device.

20. The apparatus of claim 19, and wherein the computer network communication device is an embedded web server located within the imaging device.

21. The apparatus of claim 17, and wherein the consumable comprises sheets of media upon which the apparatus can form an image, and further wherein the consumption detection device comprises a sheet counter configured to count sheets of media on which the apparatus has formed an image.

22. The apparatus of claim 17, and wherein the consumable comprises an image forming substance, and wherein the apparatus forms an image by depositing pixels of the image forming substance on sheets of media, and further wherein the consumption detection device comprises a pixel counter configured to count the number of pixels of the image forming substance which have been deposited on sheets of media to form an image.

23. The apparatus of claim 17, and wherein the consumable can be provided by a plurality of suppliers, at least one of which can be identified by inspection of the consumable, the apparatus further comprising a consumable identification detection device configured to inspect the consumable and detect whether the consumable has been supplied by the at least one supplier and to generate a supplier identification signal in response thereto.

24. The apparatus of claim 23, and wherein the processor is further configured to receive the supplier identification signal, and wherein the consumption value is further a function of the received supplier identification signal.

25. A computer-readable storage medium for use by a processor configured to execute computer executable instructions to generate a reward message in response to the consumption of a consumable by an imaging device, the medium holding computer executable instructions to:
detect consumption of the consumable; and
when the consumption of a predefined quantity of the consumable has been detected, generate a reward message.

26. The computer-readable storage medium of claim 25, and wherein the instruction to generate a reward message comprises an instruction to print a coupon using the imaging device.

27. The computer-readable storage medium of claim 25, the medium further holding computer executable instructions to connect to a global computer network and to obtain, via the global computer network, a certificate verifying the reward.

28. The computer-readable storage medium of claim 27, and wherein the instruction to connect to the global computer network and obtain the certificate verifying the reward is configured to be executed automatically in response to a detection that the predefined quantity of the consumable has been consumed.

29. The computer-readable storage medium of claim 25, and wherein the instruction to detect the consumption of the consumable comprises an instruction to calculate an estimated consumption of the consumable.

30. The computer-readable storage medium of claim 25, and wherein the consumable can be provided by a plurality of separately identified sources, the medium further holding computer executable instructions to detect at least one of the identified sources of the consumable, and to base the reward at least in part on whether the detected quantity of consumable that has been consumed comprises consumable provided by the at least one identified source.

31. The computer-readable storage medium of claim 25, and wherein the consumable comprises sheets of media, the instruction to detect the consumption of the consumable comprises an instruction to count sheets of the media consumed by the imaging device.

32. The computer-readable storage medium of claim 25, and wherein the imaging device forms an image by depositing a quantity of pixels of the image forming substance, the instruction to detect the consumption of the consumable comprises an instruction to at least one of calculate, measure, or estimate the deposited quantity of pixels of the image forming substance.

33. A computer-readable storage medium for use by a processor configured to execute computer executable instructions to generate a reward message in response to the consumption of at least one consumable by an imaging device, the medium holding computer executable instructions to:
receive consumption signals from a consumption detection device configured to detect quantities of at least one of the consumables which are consumed by the imaging device;
calculate a consumption value as a function of the received consumption signals and store the consumption value in a readable memory device;
determine when the consumption value is at least a predetermined reward value;
generate the reward message when the consumption value is at least the predetermined reward value and;
visually display the reward message.

34. The computer-readable storage medium of claim 33, the medium further holding computer executable instructions to connect a computer network communication device to a global computer network and obtain from the global communication network a reward file, and to use the reward file to generate the reward message.

35. The computer-readable storage medium of claim 33, the medium further holding computer executable instructions to receive a supplier identification signal from a consumable identification detection device configured to inspect at least one of the consumables and detect whether the at least one consumable product has been supplied by a predetermined supplier, and to use the supplier identification signal to calculate the consumption value.

36. The computer-readable storage medium of claim 33, the medium further holding computer executable instructions to cause the imaging device to print a copy of the reward message.
